(19) United States
(12) Patent Application Publication
(10) Pub. No.: US 2005/0168034 A1
(43) Pub. Date: Aug. 4, 2005

(54) Disc recliner with dual cams

(76) Inventor: Scott Fast, Macomb Twp., MI (US)

Correspondence Address: HARNESS, DICKEY & PIERCE, P.L.C., P.O. BOX 828, BLOOMFIELD HILLS, MI, 48303, US

(21) Appl. No.: 10/930,045

(22) Filed: Aug. 30, 2004

Related U.S. Application Data
(63) Continuation-in-part of application No. 10/762,228, filed on Jan. 21, 2004.

(51) Int. Cl. B60N 2/235

(52) U.S. Cl. 297/367

(57) ABSTRACT

A recliner assembly includes a first housing plate, a second housing plate, and a pawl. The pawl is movable between a locked position engaging the second housing plate to prohibit rotation of the second housing plate relative to the first housing plate and an unlocked position disengaging the second housing plate to enable rotation of the second housing plate relative to the first housing plate. A locking cam is rotatably supported by the first housing plate and is operable to engage the pawl to urge the pawl into the locked position. In addition, a main cam is provided and is rotatably supported by the first housing plate to selectively rotate the locking cam into engagement with the pawl to urge the pawl into the locked position.

### CROSS-REFERENCE TO RELATED APPLICATIONS

This application is a continuation-in-part of U.S. patent application Ser. No. 10/762,228 filed on Jan. 21, 2004. The disclosure of the above application is incorporated herein by reference.

### FIELD OF THE INVENTION

The present invention relates to recliner mechanisms, and more particularly, to a disc recliner for use with a seat assembly.

### BACKGROUND OF THE INVENTION

Rotary recliner mechanisms generally include of a first rotary member having a plurality of teeth and a second rotary member including one or more pawls adapted to lockingly engage the teeth to couple the rotary members to one another. Typically, one rotary member is mounted to a quadrant for attachment to a seat back and the second rotary member is mounted to a base plate for attachment to a seat base. The rotary recliner mechanisms are operable to lock the rotary member connected to the seat back to restrict its rotation, or to release the rotary member connected to the seat back to allow it to rotate and to enable the seat back to recline.

The rotary recliner mechanism is selectively locked or released by manipulating the one or more pawls, which are mounted for rotation between an engaged position where the teeth of the pawl and the teeth of the rotary member connected to the seat base mesh, and a disengaged position where the pawl retracts and no longer meshes with the teeth of the rotary member connected to the seat base. Locking rotary recliner mechanisms also may include a device, such as a spring, for releasably urging the pawl from the disengaged to the engaged position so that the default position for the mechanism is a locked condition. Further, the rotary recliner typically includes an activating mechanism that moves the pawl from the engaged position to the disengaged position.

In reclining seats, the seat back functions as an extremely long lever arm against which various forces are applied. The locking rotary recliner mechanism in a vehicle seat is relatively small compared to the length of the reclining seat back, and vehicle vibration or movement of an occupant may impose various forces upon that lever during use. These forces impose a large moment about the rotary member connected to the seat back when applied along such a lengthy lever arm. If the forces are sufficient, or the rotary recliner mechanism is poorly designed, these forces can overcome the capability of the rotary recliner mechanism to anchor the seat back.

In addition, any imperfection in the components of the pivot mechanisms, such as play or backlash between the engaging teeth or tolerances between the mechanism components, may allow the rotary member connected to the seat back to move a miniscule amount even when the mechanism is locked. Such small movements are magnified by the length of the lever arm and become noticeable at the upper end of the seat. For example, a seat back of an unoccupied seat may tend to oscillate when the vehicle encounters rough road conditions. Because the motion of the seat back is amplified by the length of the seat back frame, the vibration of the seat back can be relatively large. This magnified play in locking pivot mechanisms has been termed “chucking” and refers to any imperfections or play in the mechanism components that allow movement of the rotary member and attached seat back while the mechanism is in a locked condition.

One technique employed to reduce chucking is to form the components of the pivot mechanism with exceedingly close tolerances. Such techniques reduce play in the mechanism, and thus reduce chucking, but manufacturing to such close tolerance is expensive and difficult to achieve. Further, close tolerances may bind the components of the system and prevent smooth operation.

Therefore, a recliner mechanism that is operable to lock a seat back relative to a seat bottom in a plurality of positions while preventing chucking is desirable in the industry. Furthermore, a recliner mechanism that prevents chucking without requiring extensive and expensive manufacturing techniques is also desirable.

### SUMMARY OF THE INVENTION

Accordingly, a recliner assembly is provided and includes a first housing plate, a second housing plate, and a pawl. The pawl is movable between a locked position engaging the second housing plate to prohibit rotation of the second housing plate relative to the first housing plate and an unlocked position disengaging the second housing plate to enable rotation of the second housing plate relative to the first housing plate. A locking cam is rotatably supported by the first housing plate and is operable to engage the pawl to urge the pawl into the locked position. In addition, a main cam is provided and is rotatably supported by the first housing plate to selectively rotate the locking cam into engagement with the pawl to urge the pawl into the locked position.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a recliner mechanism in accordance with the principals of the present invention;

FIG. 2A is an exploded view of the recliner mechanism of FIG. 1;

FIG. 2B is a more detailed view of particular components of FIG. 2A.

FIG. 3 is a plan view of the recliner mechanism of FIG. 1 with part of a housing removed to show the internal workings of the recliner mechanism in a locked position;

FIG. 4 is a plan view of the recliner mechanism of FIG. 1 with part of a housing removed to show the internal workings of the recliner mechanism in a locked position;

FIG. 5 is a plan view of the recliner mechanism of FIG. 1 with part of a housing removed to show a more detailed view of the internal workings of the recliner mechanism in an unlocked position;

FIG. 6 is a plan view of the recliner mechanism of FIG. 1 with part of a housing removed to show the internal workings of the recliner mechanism in an unlocked position;

FIG. 7 is a plan view of the recliner mechanism of FIG. 1 incorporated into a seat assembly;

FIG. 8 is a perspective view of a recliner mechanism in accordance with the principals of the present invention;

FIG. 9A is an exploded view of the recliner mechanism of FIG. 8;

FIG. 9B is a more detailed view of particular components of FIG. 9A.

FIG. 10 is a plan view of the recliner mechanism of FIG. 8 with part of a housing removed to show the internal workings of the recliner mechanism in a locked position;

FIG. 11 is a plan view of the recliner mechanism of FIG. 8 with part of a housing removed to show the internal workings of the recliner mechanism in a locked position;

FIG. 12 is a plan view of the recliner mechanism of FIG. 8 with part of a housing removed to show a more detailed view of the internal workings of the recliner mechanism in an unlocked position;

FIG. 13 is a plan view of the recliner mechanism of FIG. 8 with part of a housing removed to show the internal workings of the recliner mechanism in an unlocked position; and

FIG. 14 is a plan view of the recliner mechanism of FIG. 8 incorporated into a seat assembly.

### DETAILED DESCRIPTION OF THE PREFERRED EMBODIMENTS

The following description of the preferred embodiment is merely exemplary in nature and is in no way intended to limit the invention, its application, or uses.

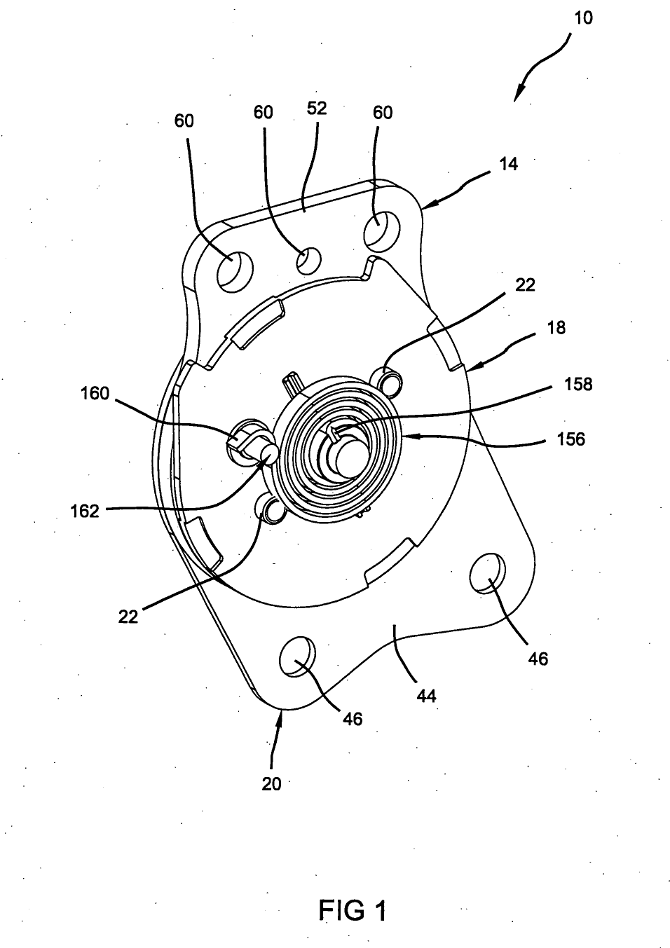

With reference to FIGS. 1-7, a recliner mechanism 10 is provided an includes a housing 12, a sector plate 14, and a lock mechanism 16. The sector plate 14 and lock mechanism 16 are supported by the housing 12, whereby the lock mechanism 16 is operable to selectively lock the sector plate 14 in a plurality of positions relative to the housing 12, as will be described further below.

The housing 12 includes an inner housing plate 18 and an outer housing plate 20 fixedly attached by a pair of rivets 22. The rivets 22 include a central cylindrical section 24 and flanking cylindrical sections 26. The flanking cylindrical sections 26 are fixedly received by attachment apertures 28 formed in the inner and outer housing plates 18, 20 and serve to fixedly attach the inner housing plate 18 to the outer housing plate 20. In this manner, the center cylindrical section 24 is disposed between the inner and outer plates 18, 20 and serves to set the relative spacing therebetween.

The inner housing plate 18 includes a central aperture 30, a spring aperture 32, and a pair of slots 34. The outer housing plate 20 similarly includes a central aperture 36, a spring aperture 38, and a pair of slots 40, whereby the central aperture 36, spring aperture 38, and slots 40 are coaxially aligned with the respective central aperture 30, spring aperture 32, and slots 34 of the inner housing plate 20 once the inner housing plate 18 is fixedly attached to the outer housing plate 20 by rivets 22.

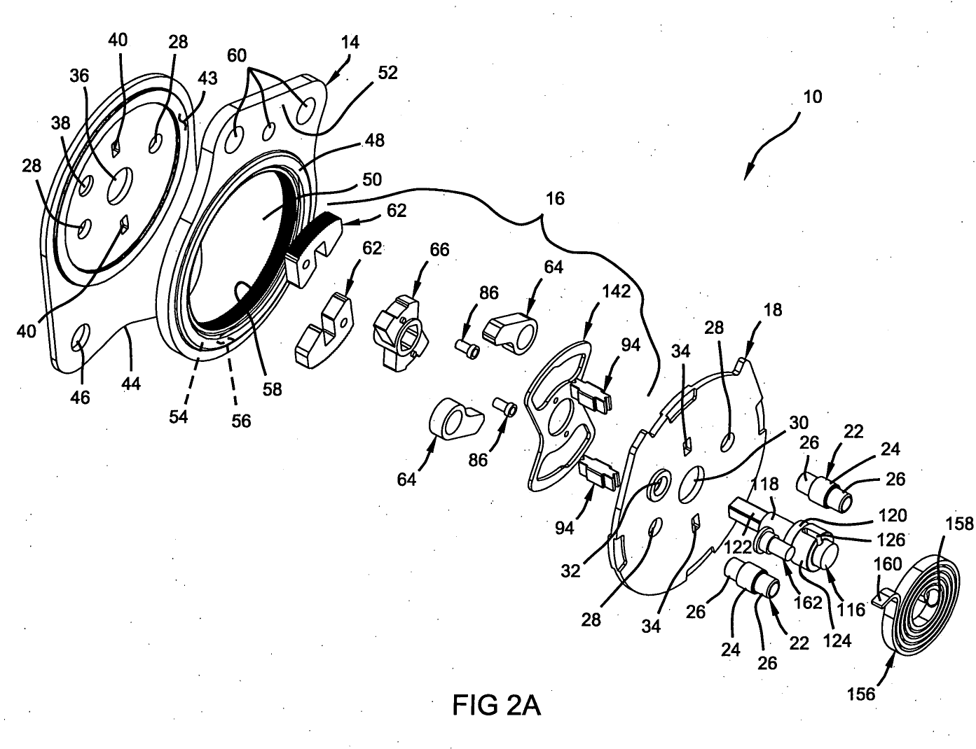

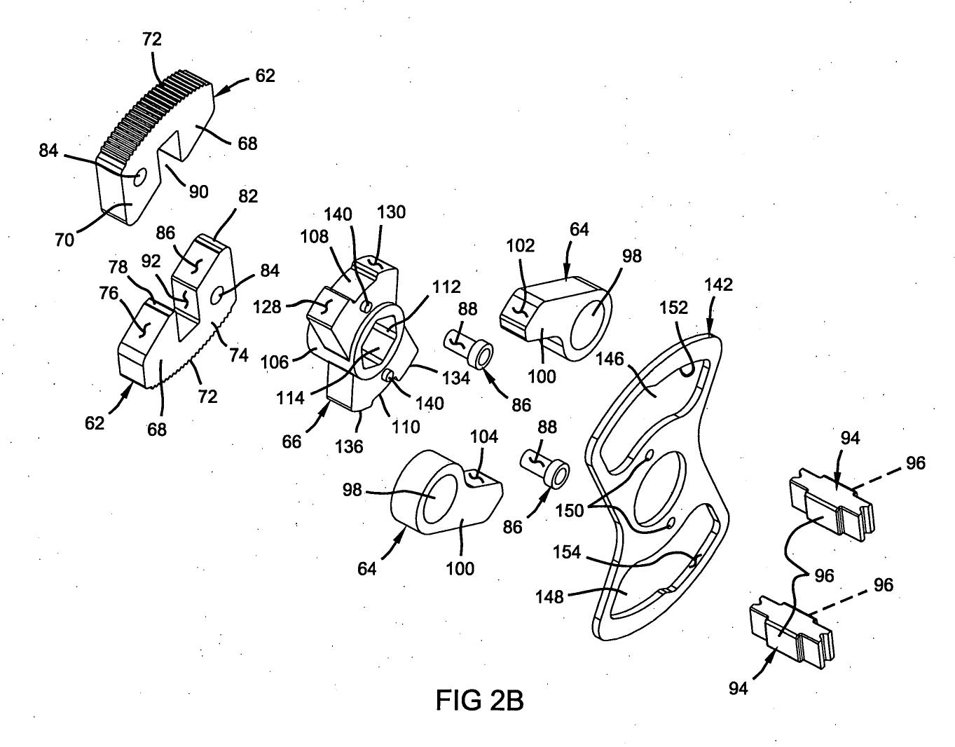

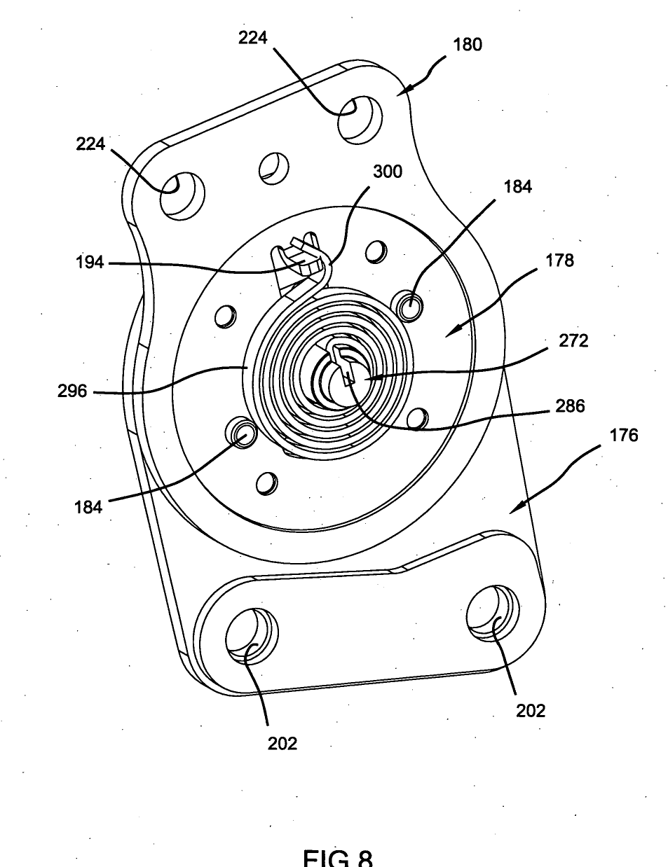

The outer housing plate 20 further includes a raised flange 42 and an arm 44, whereby the raised flange 42 is operable to engage the sector plate 14 and the arm 44 is operable to attach the outer housing plate 20 to an external structure, as will be discussed further below. The raised flange 42 comprises a substantially circular shape and includes an engagement surface 43 for interaction with the sector plate 14. Furthermore, the flange 42 generally encircles attachment apertures 28, central aperture 30, spring aperture 32, and slots 34, as best shown in FIGS. 2A and 2B. The arm 44 extends from the outer housing plate 20 and includes a pair of attachment apertures 46 for interaction with an external structure, as best shown in FIGS. 2 and 8.

The sector plate 14 is rotatably supported between the inner and outer housing plates 18, 20 and includes a flange 48, a central aperture 50, and an arm 52. The flange 48 generally encircles the central aperture 50 and includes a recess 54 having an engagement surface 56 operable to rotatably receive the engagement surface 43 of the outer housing plate 20. In this manner, rotation of the sector plate 14 relative to the inner and outer housing plates 18, 20 is governed by the interaction between the engagement surface 43 of flange 42 and engagement surface 56 of flange 48.

The central aperture 50 is coaxially aligned with the flange 48 and includes a plurality of teeth 58 formed on an inner surface thereof. The arm 52 extends from the central aperture 50 an includes a plurality of attachment apertures 60. The attachment apertures 60 are operable to fixedly attach the sector plate 14 to an external structure, as will be described in greater detail below.

The locking mechanism 16 is operable to selectively lock the sector plate 14 in a plurality of radial positions relative to the inner and outer housing plates 18, 20 and includes a pair of pawls 62, a pair of locking cams 64, and a main cam 66.

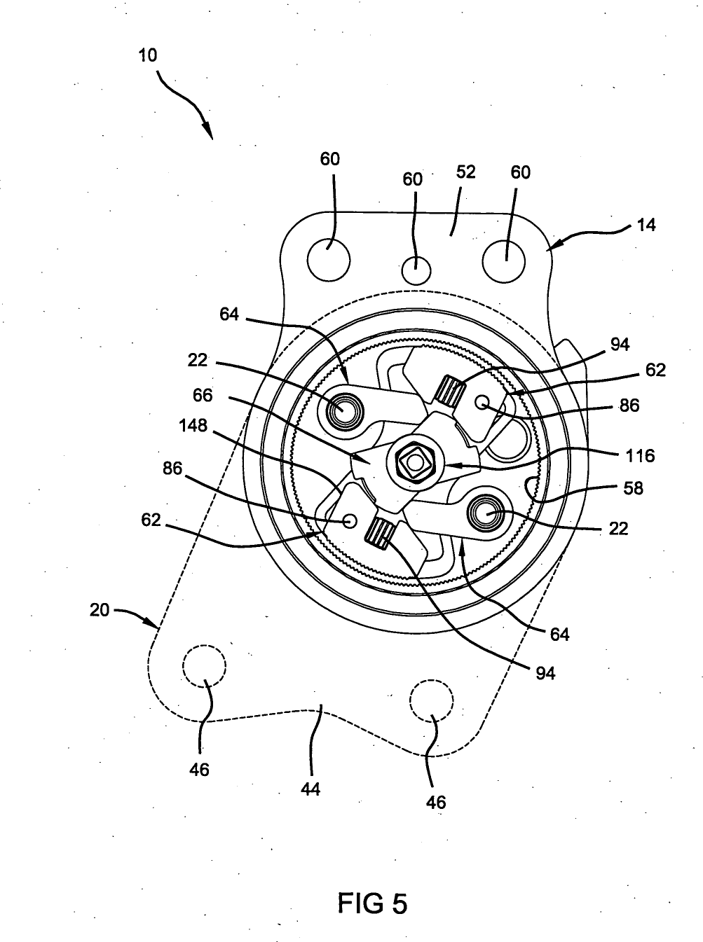

The pawls 62 each include a first arm 68, a second arm 70, and a plurality of teeth 72 formed on an arcuate surface 74. The first arm 68 includes a reaction surface 76 formed at an angle Θ relative to a top surface 78 of the first arm 68, whereby Θ is substantially between 14-22 degrees. The angular relationship between the reaction surface 76 and the top surface 78 is further depicted in FIG. 5, whereby the planar reaction surface 76 and planar top surface 78 have each been extended to more clearly depict the angular relationship therebetween.

The second arm 70 similarly includes a reaction surface 80 formed at an angle Θ relative to a top surface 82, whereby Θ is substantially between 14-22 degrees. In this regard, the reaction surface 76 of the first arm 68 is formed at a generally equivalent angle to that of the reaction surface 80 of the second arm 70, as best represented in FIG. 5. In addition, the second arm 70 further includes an attachment aperture 84 formed therethrough. The attachment aperture fixedly receives a pin 86, whereby the pin 86 includes a reaction surface 88 formed along its length for interaction with a release mechanism, as will be described in more detail below.

Each pawl 62 further includes a recess 90 having a reaction surface 92 formed between the first and second arms 68, 70 for interaction with a respective post 94. The posts 94 are fixedly received by slots 34 and 40 of the inner and outer housing plates 18, 20, respectively, and serve to define a range of motion for each pawl 62 and to further set the relative positional relationship between the inner and outer housing plates 18, 20. Specifically, each post 94 includes a pair of planar side walls 96 which are slidably received by the reaction surface 92 of recess 90. In this manner, the posts 94 restrict lateral movement of the pawl 62 relative to the inner and outer housing plates 18, 20 and only provide for up and down movement of the pawl 62 between a locked position and an unlocked position.

As will be described in greater detail below, the locked position is achieved when the pawls 62 are moved along the posts 94 to a point when teeth 72 are meshed with teeth 58 of the sector plate 14. At this point, the sector plate 14 is restricted from rotating relative to the inner and outer housing plates 18, 20 due to the engagement between the pawls 62 and central bore 50 of the sector plate 14. Conversely, the unlocked position is achieved when the pawls 62 are traversed along the posts 94 to a point when teeth 72 of the pawls 62 are released from engagement with teeth 58 of the sector plate 14. As can be appreciated, when the pawls 62 are disengaged from the sector plate 14, the sector plate 14 is free to rotate relative to the inner and outer housing plates 18, 20.

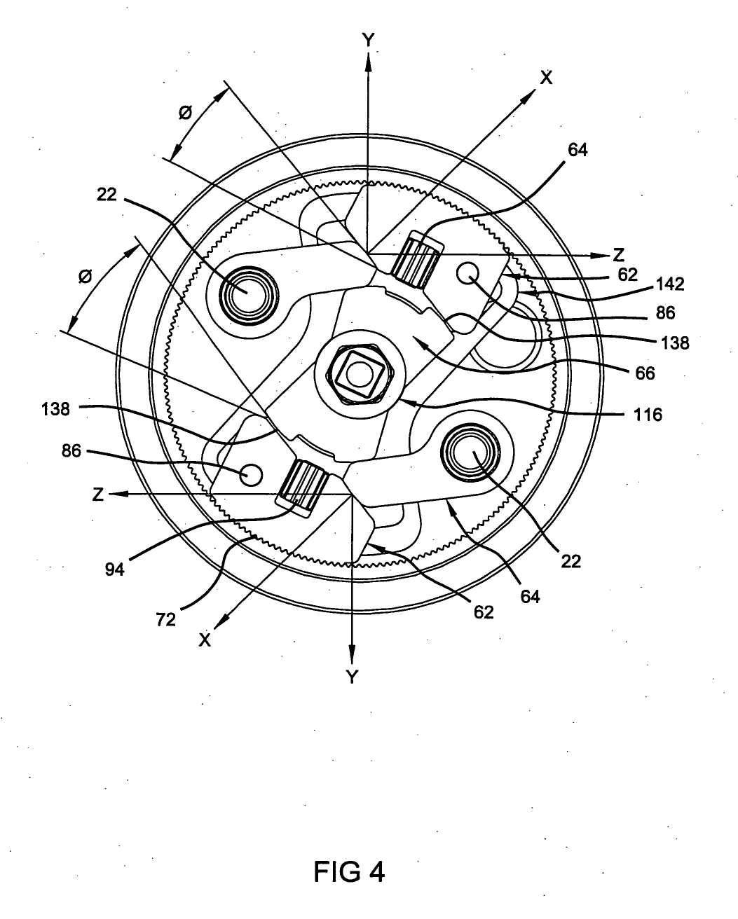

The locking cams 64 include a central attachment aperture 98 and an arm 100 extending from the central attachment aperture 98, as best shown in FIGS. 2A and 2B. Each central attachment aperture 98 rotatably receives the central cylindrical section 24 of rivet 22 to allow the locking cams 64 to freely rotate relative to the inner and outer housing plates 18, 20. The arm 100 includes a first reaction surface 102 and a second reaction surface 104. The first reaction surface 102 is formed proximate to, and facing reaction surface 76 of pawl 62. The reaction surface 102 is formed at an angular relationship with the locking cam 64 so as to matingly engage the reaction surface 76 of the pawl 62, as best shown in FIGS. 4 and 5. The second reaction surface 104 is formed opposite from the first reaction surface 102 and generally faces the main cam 66.

The main cam 66 includes a main cylindrical body 106 and a first and second arm 108, 110 formed integrally therewith. The main cylindrical body 106 includes a bore 112 formed therethrough having a plurality of flats 114. The flats 114 matingly receive a main pivot 116 to rotatably support the main cam 66 between the first and second housing plate 18, 20. More particularly, the main pivot 116 includes a keyed cylindrical section 118 for mating engagement with flats 114 such that the main cam 66 is fixed for rotation with the main pivot 116. In addition, the main pivot 116 includes a cylindrical section 120 and a square section 122 disposed on opposite sides of keyed section 118 and a cylindrical section 124 having a spring seat 126, as best shown in FIGS. 2A and 2B. The main pivot 116 is rotatably received through central apertures 30, 36 of the inner and outer housing plates 18, 20, respectively, such that cylindrical section 124 and spring seat 126 extend from an outer surface of inner housing plate 18, as best shown in FIG. 1.

The first arm 108 includes a first reaction surface 128 and a second reaction surface 130. The first reaction surface 128 is in abutting engagement with reaction surface 104 of the locking cam 64 when the pawl 62 and locking cam 64 are in the locked position, as best shown in FIGS. 4 and 5. The second reaction surface 130 is spaced apart from the second arm 70 of the pawl 62 a predetermined distance such that a gap 132 is created therebetween. In this manner, the main cam 66 is not in contact with the pawl 62 when the pawl 62 is in the locked position. Providing a gap 132 between the main cam 66 and the pawl 62 when the pawl 62 is in the locked position allows the main load path or lock path to extend between the main cam 66, lock cam 64, and pawl 62, as best shown in FIG. 5. In other words, the pawl 62 is held in engagement with the sector plate 14 due to the interaction between the first reaction surface 128 of the main cam 66, lock cam 64, and pawl 62. As will be described further below, such a relationship provides the recliner mechanism 10 with a more desirable operation as less force is required to toggle the recliner mechanism 10 between the locked and unlocked positions.

The second arm 110 similarly includes a first reaction surface 134 and a second reaction surface 136, as best shown in FIGS. 2A and 2B. The first reaction surface 134 is in abutting engagement with the first arm 68 of the pawl 62 while the second reaction surface 136 is spaced apart from the second arm 70 of the pawl 62, thereby creating a gap 138 therebetween. In this manner, the main cam 66 cooperates with the respective locking cams 64 to urge the pawls 62 into the locked position, as will be described further below.

The main cam 66 further includes a pair of posts 140 extending from the respective first and second arms 108, 110, as best shown in FIGS. 2A and 2B. The posts 140 are adapted to engage a release cam 142 to fix the release cam 142 to the main cam 66 for rotation therewith.

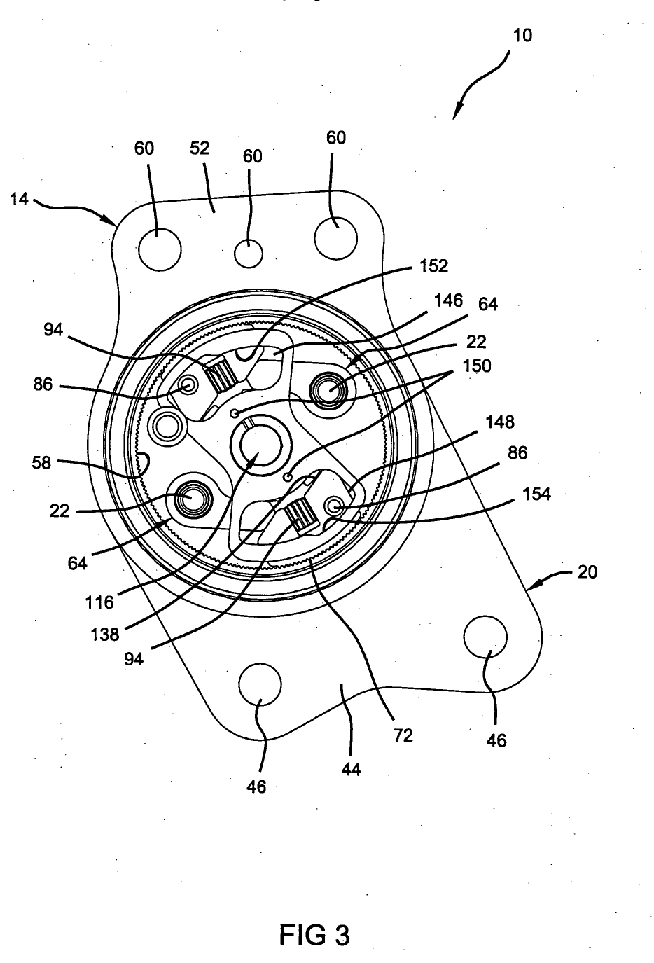

The release cam 142 is a substantially flat member having a central attachment aperture 144, a first cam aperture 146, a second cam aperture 148, and a pair of attachment apertures 150. The central aperture 144 is rotatably received by cylindrical section 120 of the main pivot 116 such that the release cam 142 freely rotates relative to the inner and outer housing plates 18, 20. The first cam aperture 146 includes a cam surface 152 operable to engage the reaction surface 88 of pin 86 while the second cam aperture 148 similarly includes a cam surface 154 operable to engage reaction surface 88 of pin 86, as bests shown in FIG. 3. The attachment apertures 150 fixedly receive posts 140 of the main cam 66 such that as the main cam 66 rotates, the release cam 142 will rotate therewith. In operation, rotation of the main cam 66 causes concurrent rotation of the release cam 142, thereby causing the pin 86 to travel along the respective cam surfaces 152, 154. Such movement of the respective pins 86 causes the pawls 62 to disengage the sector plate 14 and permit rotation of the sector plate 14 relative to the inner and outer housing plates 18, 20, as will be described further below.

The main cam 66 biases the pawls 62 into the locked position via locking cams 64 due to the interaction of the main pivot 116 and a coil spring 156. The coil spring 156 is disposed on an outer surface of the inner plate 18 and includes a central flat 158 and an outwardly extending arm 160. The central flat 158 is matingly received by the spring seat 126 of the main pivot 116 while the arm 160 engages a spring post 162, as best shown in FIG. 1. The spring post 162 is fixedly received by spring aperture 32 of the inner housing plate 18 and serves to fix the position of arm 160 relative to the inner housing plate 18. In this manner, the coil spring 156 biases the main pivot 116 in the counterclockwise direction (CCW) relative to the view shown in FIG. 4, thereby causing the main cam 66 to position the locking cams 64 and pawls 62 in the locked position.

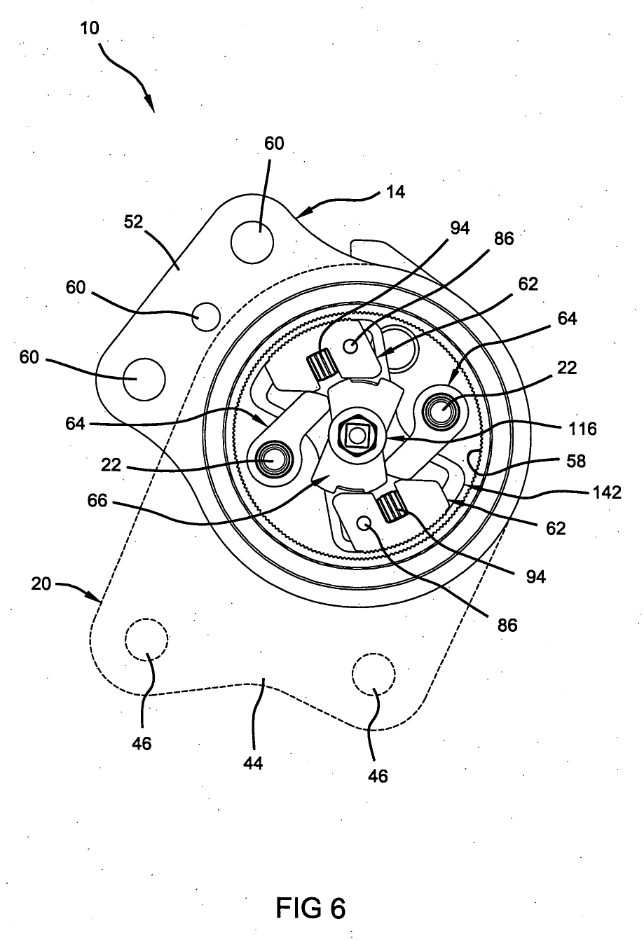

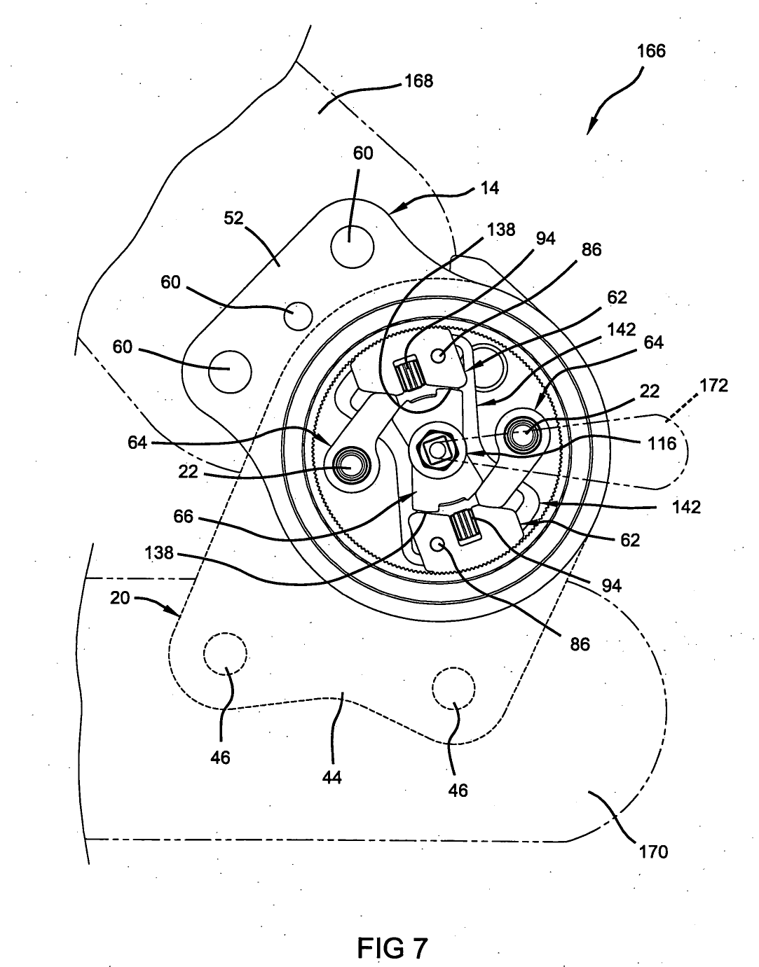

With particular reference to FIGS. 3-8, the operation of the recliner mechanism 10 will be described in detail. In a first operational mode, a force is applied to the main pivot 116 to rotate the main pivot 116 against the bias of the coil spring 156. Such rotation of the main pivot causes the main cam 66 to rotate, thereby causing reaction surfaces 128, 134 of the main cam .66 to disengage reaction surface 104 of the locking cams 64. Once the reaction surfaces 128, 134 have released the locking cams 64, the locking cams 64 are permitted to rotate relative to the inner and outer housing plates 18, 20, as best shown in FIGS. 6 and 7. As can be appreciated, once the reaction surfaces 128, 134 are released from engagement with the locking cams 64, the pawls 62 are free to travel along posts 94 relative to the inner and outer housing plates 18, 20 due to the interaction between the posts 86 and the release cam 142.

Rotation of the release cam 142 caused by rotation of the main cam 66 causes pins 86 to travel along the respective cam surfaces 152, 154 of the cam apertures 146, 148. Upon sufficient rotation of the release cam 142, the pins 86 will encounter a raised portion 164 formed on said cam surfaces 152, 154, thereby causing the pawls 62 to translate relative to the inner and outer housing plates 18, 20. More particularly, as the pins 86 move along the cam surfaces 152, 154, the pawls 62 are caused to move concurrently therewith along the posts 94 due to the pins 86 being fixedly attached to the respective pawls 62, as previously discussed. Translation of the pawls 62 is permitted as reaction surfaces 128, 134 have released the locking cams 64, as best shown in FIGS. 6 and 7.

The shape of the cam surfaces 152, 154 are designed such that the pins 86 will not encounter the raised portion 164 until the main pivot 116 has sufficiently rotated and the reaction surfaces 128, 134 from engagement with the locking cams 64. As can be appreciated, if the pins 86 encounter the raised portions 164 of the respective cam surfaces 152, 154 before the locking cams 64 have been released from the reaction surfaces 128, 134, the pawls 62 would not be permitted to translate relative to the inner and outer housing plates 18, 20 and the recliner mechanism 10 may bind.

Once the pins 86 have sufficiently translated the pawls 62 relative to the inner and outer housing plates 20, the teeth 72 of the pawls 62 will disengage the teeth 58 of the sector plate 14, thereby permitting the sector plate 14 to rotate relative to the inner and outer housing plates 18, 20. At this point, the recliner mechanism 10 is in the unlocked position.

To return the recliner mechanism 10 to the locked condition, the force is released from the main pivot 116 such that the coil spring 156 is permitted to once again bias the maim pivot 116. The coil spring 156 will bias the main pivot 116 and rotate the main cam 66 and release cam 142 into the locked position. Specifically, sufficient rotation of the main cam 66 will cause reaction surfaces 128, 134 to contact the locking cam 64, thereby rotating the locking cams 64 about pivots 22. Such rotation of the locking cams 64 causes reaction surface 102 to apply a primary force X to the pawls 64, thereby causing the pawls 64 to translate relative to the inner and outer housing plates 18, 20.

The pawls 62 are permitted to translate due to the shape of the respective cam apertures 146, 148. Specifically, as the main cam 66 is rotated due to the bias of spring 156, the pins 86 travel along the cam surfaces 152, 154 generally away from the raised portion 164. Once the pins 86 move from engagement with the raised surface 164, the pawls 62 are free to be translated relative to the inner and outer housing plates 18, 20 due to the primary force X exerted thereon by locking cams 64, as best shown in FIG. 5. Upon sufficient translation, the teeth 72 of the pawls 62 will again engage the teeth 58 of the sector plate 14, thereby returning the recliner mechanism 10 to the locked position.

The recliner mechanism 10 is held in the locked position due the interaction between the main cam 66, locking cams 64, and pawls 62, as previously discussed. The rotational force imparted on the main cam 66 due to the coil spring 156, causes the reaction surfaces 128, 134 to contact the reaction surface 104 of the respective locking cams 64, thereby causing the locking cams 64 to rotate about rivets 22 and engage the pawls 62. More particularly, the reaction surfaces 102 engage the reaction surface 76 of the respective pawls 62 and apply the primary force X thereon. Due to the angular relationship between reaction surface 76 and the locking cam 64, the primary force X is applied at an angle Θ relative to the pawls 62, whereby E) is substantially between 14-22 degrees, as previously discussed.

The primary force X comprises resultant forces Y and Z due to the angular relationship between reaction surface 76 and locking cams 64, as best shown in FIG. 5. Resultant force Y imparts a force on the pawls 62 generally normal to the teeth 58, 72 and serves to hold the pawls 62 in contact with the teeth 58 of the sector plate 14. Resultant force Z applies a force generally in the direction of rotation of the sector plate 14 and serves to maintain the teeth 58 of the sector plate 14 in engagement with the teeth 72 of the pawls 62. In this manner, the resultant forces Y, Z restrict movement between the teeth 58 of the sector plate 14 and the teeth 72 of the pawls 62 such that even small variations between the teeth 58, 72 are prevented from causing a slip or rattle condition during use.

The angular relationship between reaction surface 102 of the locking cams 64 and the reactor surface 76 of the pawls 62 allows the sector plate 14 to be securely held in the locked position when the pawls 62 are engaged with the sector plate 14. In addition, such an angular relationship (i.e. where Θ is substantially between 14-22 degrees) reduces the force required to overcome the interaction between the locking cams 64 and the pawls 62. In other words, the angular relationship ensures that the main cam 66, locking cams 64, and pawls 62 will sufficiently lock the sector plate 14 relative to the inner and outer housing plates 18, 20 while concurrently optimizing the force required to release the pawls 62 from engagement with the sector plate 14 and permit rotation of the sector plate 14 relative to the inner and outer housing plates 18, 20.

With respect to FIG. 7, a seat assembly 166 is shown incorporating the recliner mechanism 10 of the present invention. The seat assembly 166 includes a seat back 168, a seat bottom 170, and an actuation handle 172. The seat back 168 is pivotably supported by the seat bottom 170 having the recliner mechanism 10 disposed therebetween. The actuation handle 172 is fixedly attached to the main pivot 116 such that a rotational force applied to the actuation handle 172 is transmitted to the main pivot 116.

In one embodiment, the sector plate 14 is fixedly attached to the seat back 168 and the outer housing plate 20 is fixedly attached to the seat bottom 170 such that rotation of the sector plate 14 relative to the outer housing plate 20 causes concurrent rotation of the seat back 168 relative to the seat bottom 170. Alternatively, the sector plate 14 could be fixedly attached to the seat bottom 168 and the outer housing plate 20 fixedly attached to the seat back 168 such that rotation of the outer housing plate 20 relative to the sector plate 14 causes concurrent rotation of the seat back 168 relative to the seat bottom 170.

In either configuration, a force is applied to the actuation handle 172 to rotate the main pivot 116 against the bias of coil spring 156. As previously discussed, such rotation will cause the main cam 66 to rotate and release the pawls 62 from engagement with the sector plate 14. Once the pawls 62 are released, a force may be applied to rotate the seat back 168 relative to the seat bottom 170. Once the desired position for the seat back 168 is achieved, the actuation handle 172 is released, and the pawls 62 will re-engage the sector plate 14, thereby locking the seat back 168 in the desired position relative to the seat bottom 170.

As previously discussed, the main cam 66, locking cam 64, and pawls 62 serve to lock the sector plate 14 to the outer housing plate 20. However, if a sufficient force is applied to the seat back 168, the pawls 62 are further held in the locked position by the interaction between reaction surfaces 130, 136 and the pawls 62. More particularly, if the recliner mechanism 10 experiences a sufficient load, the reaction surfaces 130, 136 will close the gaps 132, 138 between the second arm 70 of the pawls 62 and the main cam 66 until the reaction surfaces 130, 136 engage the reaction surfaces 80 of the pawls 62. In this manner, the main cam 66 further ensures engagement between the pawls 62 and the sector plate 14, thereby maintaining the recliner mechanism 10 in the locked position.

FIGS. 8-14 depict an alternative recliner mechanism 174 including an outer housing plate 176, an inner housing plate 178, a sector plate 180, and a lock mechanism 182. The sector plate 180 and lock mechanism 182 are supported by the outer housing plate 176, whereby the lock mechanism 182 is operable to selectively lock the sector plate 180 in a plurality of positions relative to the inner and outer housing plates 178, 176, as will be described further below.

The inner housing plate 178 and outer housing plate 176 are fixedly attached by a pair of rivets 184. The rivets 184 each include a central cylindrical section 186 and flanking cylindrical sections 188. The flanking cylindrical sections 188 are fixedly received by attachment apertures 190 formed in the inner and outer housing plates 178, 176 and serve to fixedly attach the inner housing plate 178 to the outer housing plate 176. In this manner, the central cylindrical section 186 is disposed between the inner and outer plates 178, 176 and serves to set the relative spacing therebetween.

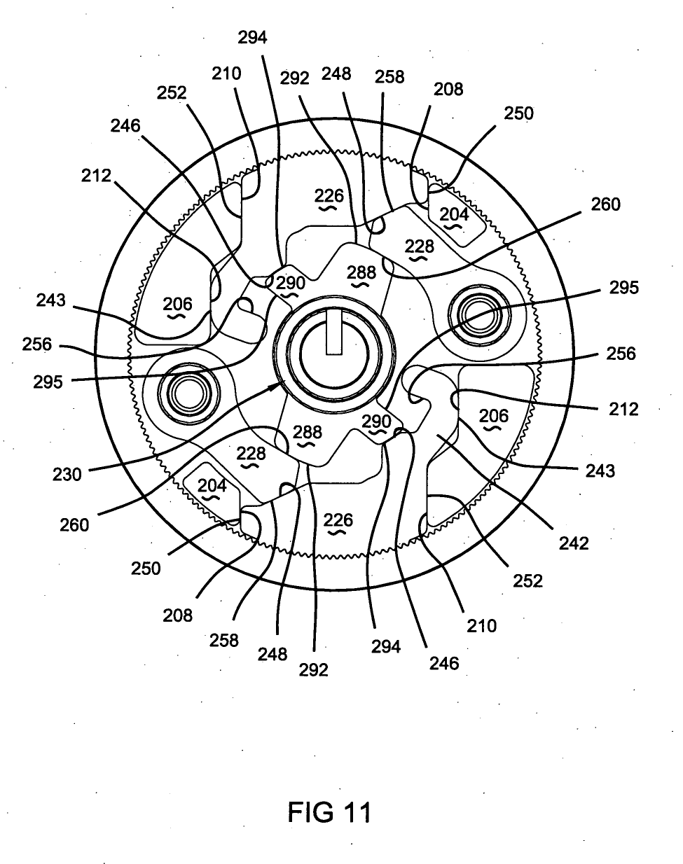

The inner housing plate 178 includes a central aperture 192 and a spring tab 194. The outer housing plate 176 includes a central aperture 196, an arm 198, and a cylindrical recess 200. The arm 198 includes a pair of attachment apertures 202. The attachment apertures 202 are adapted to receive fasteners (not shown) to attach the recliner mechanism 174 to a vehicle seat. The cylindrical recess 200 includes a pair of minor guide bosses 204 and a pair of major guide bosses 206. The minor and major guides bosses 204, 206 append axially from the cylindrical recess 200. The minor guide bosses 204 each include a sliding surface 208, as shown in FIG. 11. The major guide bosses 206 each include a first sliding surface 210 and a second sliding surface 212, as shown in FIG. 11.

The sector plate 180 is rotatably supported between the inner and outer housing plates 178, 176 and includes an arm 214 and a central aperture 216. The central aperture 216 includes a recess 218 having an engagement surface 220 operable to rotatably receive the inner housing plate 178.

The central aperture 216 includes a plurality of teeth 222 formed on an inner surface thereof. The arm 214 extends from the central aperture 216 an includes a plurality of attachment apertures 224. The attachment apertures 224 are operable to fixedly attach the sector plate 180 to an external structure, as will be described in greater detail below.

The lock mechanism 182 is operable to selectively lock the sector plate 180 in a plurality of rotational positions relative to the inner and outer housing plates 178, 176 and includes a pair of pawls 226, a pair of locking cams 228, and a main cam 230.

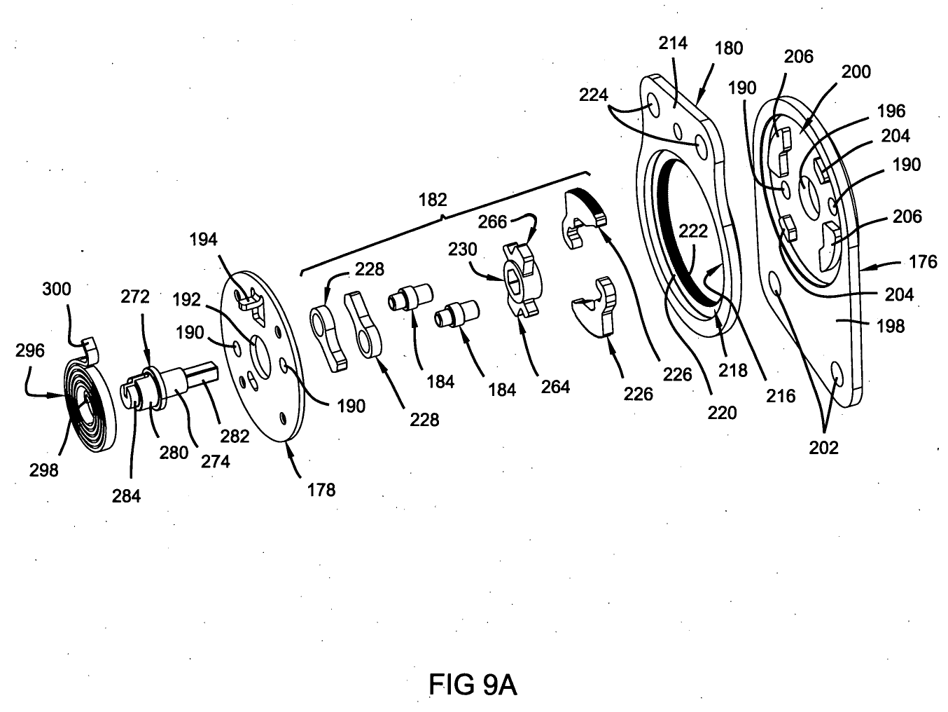

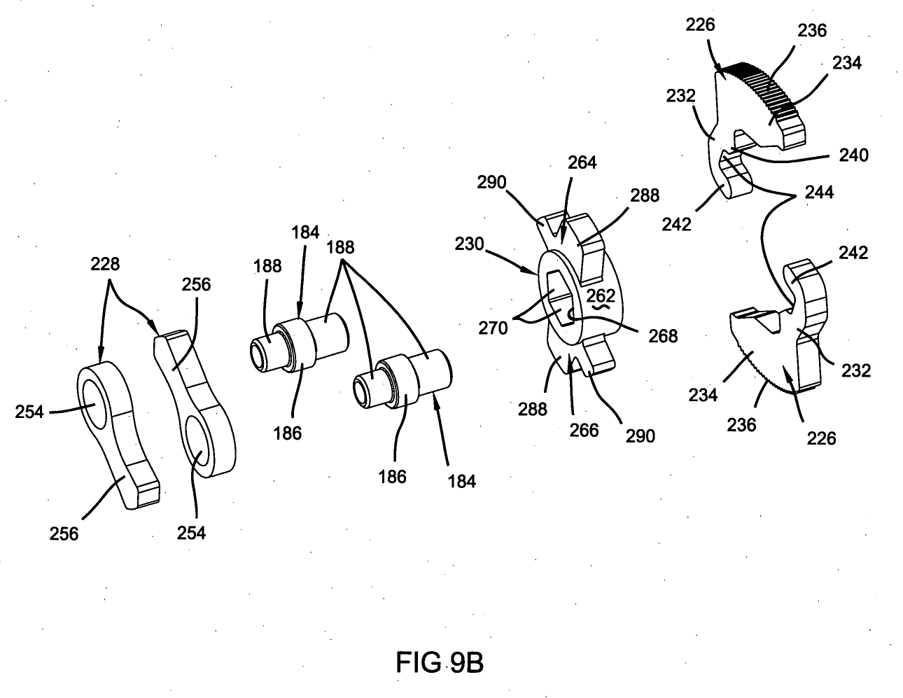

FIG. 9B depicts the pawls 226 each including an arm 232, a body 234, and a plurality of teeth 236. The arm 232 includes a hip 240 and an elbow 242 defining a pocket 244. FIG. 11 depicts the hip 240 including a first reaction surface 246; the elbow 242 including a first sliding surface 243; and the pocket 244 including a second reaction surface 245. The body 234 includes a third reaction surface 248, a second sliding surface 250, and a third sliding surface 252. The first sliding surfaces 243 of the elbows 242 are in sliding engagement with the second sliding surfaces 212 on the major guide bosses 206. The second sliding surfaces 250 on the bodies 234 are disposed opposite a minute gap from the sliding surfaces 208 of the minor guide bosses 204. Under high loads, the sliding surfaces 208 of the minor guide bosses 204 are adapted to be engaged by and support the second sliding surfaces 250 of the bodies 234 of the pawls 226. The third sliding surfaces 252 of the bodies 234 are in sliding engagement with the first sliding surfaces 210 of the major guide bosses 206. The above-described sliding engagements ensure linear radial displacement of the pawls 226 during operation of the recliner mechanism 174, which will be discussed in more detail below. The plurality of teeth 236 on the pawls 226 are operable to selectively engage the plurality of teeth 222 on the inner surface of the central aperture 216 in the sector plate 180 to lock the recliner mechanism 174, as will be described in more detail below.

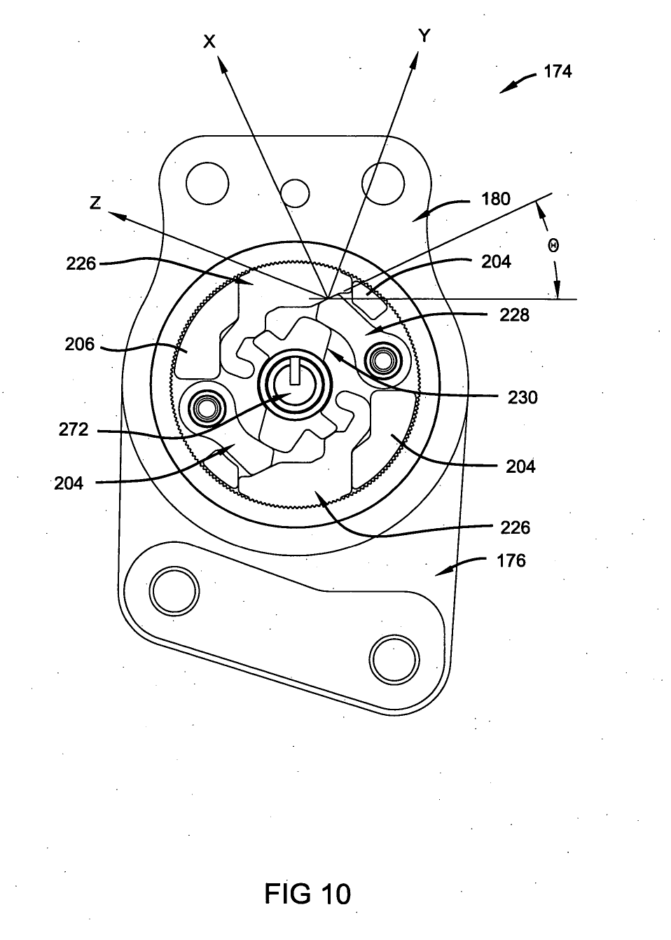

The locking cams 228 include a central attachment aperture 254 and an arm 256 extending from the central attachment aperture 254. Each central attachment aperture 254 rotatably receives the central cylindrical section 186 of rivets 184 to allow the locking cams 228 to rotate relative to the inner and outer housing plates 178, 176. The arms 256 each include a first reaction surface 258 and a second reaction surface 260, as shown in FIG. 11. The first reaction surfaces 258 are positioned proximate to and facing the reaction surfaces 248 of the pawls 226. The first reaction surfaces 258 are positioned at an angular relationship with the locking cam 228 so as to matingly engage the reaction surface 248 of the pawl 226, as best shown in FIGS. 10 and 11. The second reaction surfaces 260 are formed generally opposite the arm 256 from the first reaction surface 258 and generally faces the main cam 230.

The main cam 230 includes a main cylindrical body 262 and a first and second arm 264, 266 formed integrally therewith. The main cylindrical body 262 includes a bore 268 formed therethrough having a plurality of flats 270. The flats 270 matingly receive a main pivot 272 to rotatably support the main cam 230 between the inner and outer housing plates 178, 176. More particularly, the main pivot 272 includes a keyed cylindrical section 274 for mating engagement with flats 270 such that the main cam 230 is fixed for rotation with the main pivot 272. In addition, the main pivot 272 includes a cylindrical section 280 and a square section 282 disposed on opposite sides of keyed section 274 and a cylindrical section 284 having a spring seat 286, as best shown in FIGS. 8 and 9A. The main pivot 272 is rotatably received through central apertures 192, 196 of the inner and outer housing plates 178, 176, respectively, such that cylindrical section 284 and spring seat 286 extend from an outer surface of inner housing plate 178, as best shown in FIG. 1.

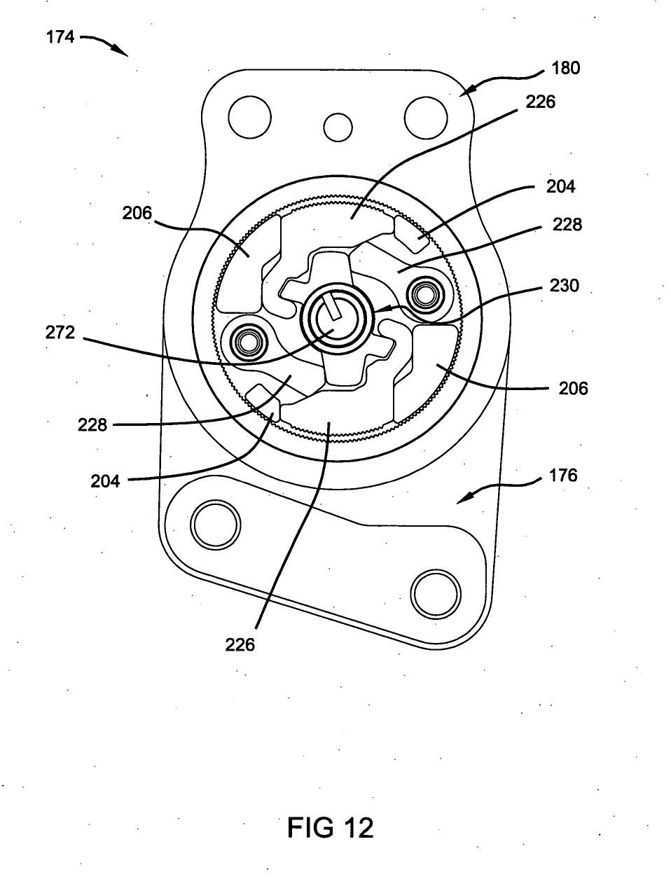

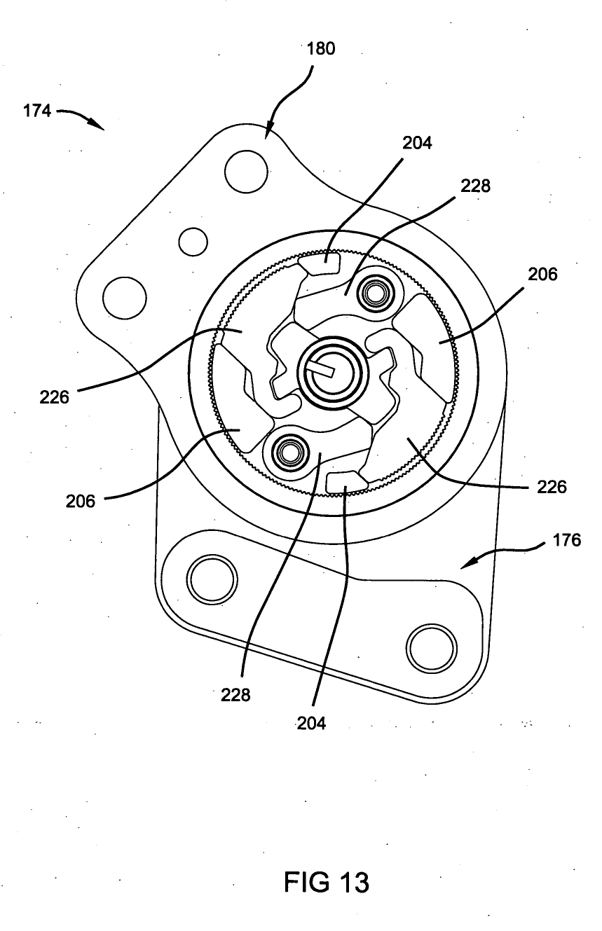

FIGS. 9B and 11 depict the first and second arms 264, 266 of the main cam 230 each including a major finger 288 and a minor finger 290. The major fingers 288 include a first reaction surface 292 in abutting engagement with reaction surface 260 of the locking cam 228 when the pawls 226 and locking cams 228 are in the locked position, as best shown in FIGS. 10 and 11. The minor fingers 290 include second reaction surfaces 294 and third reaction surfaces 295. The second reaction surfaces 294 are in abutting engagement with reaction surfaces 246 on the hips 240 of the pawls 226 when the pawls 226 and the locking cams 228 are in the locked position. The third reaction surfaces 295 are in abutting engagement with the second reaction surfaces 245 of the pockets 244 of the pawls 226 when the pawls 226 and locking cams 228 are in an unlocked position, as best shown in FIGS. 12 and 13.

The main cam 230 biases the pawls 226 into the locked position via locking cams 228 due to the interaction of the main pivot 272 and a coil spring 296. The coil spring 296 is disposed on an outer surface of the inner plate 178 and includes a central flat 298 and an outwardly extending arm 300. The central flat 298 is matingly received by the spring seat 286 of the main pivot 272 while the arm 300 engages the spring tab 194 on the inner housing plate 178, as best shown in FIG. 1. The spring tab 194 serves to fix the position of arm 300 relative to the inner housing plate 178. In this manner, the coil spring 296 biases the main pivot 272 in the clockwise direction (CW) relative to the view shown in FIG. 11, thereby causing the main cam 230 to position the locking cams 228 and pawls 226 in the locked position.

With particular reference to FIGS. 10-14, the operation of the recliner mechanism 174 will be described in detail. In a first operational mode, a clockwise force is applied to the main pivot 272 to rotate the main pivot 272 against the bias of the coil spring 296. Such rotation of the main pivot causes the main cam 230 to rotate clockwise, thereby causing reaction surfaces 292, 294 of the main cam 230 to disengage reaction surfaces 260 of the locking cams 228 and reaction surfaces 246 of the pawls 226. The locking cams 228 are then permitted to rotate relative to the inner and outer housing plates 178, 176, as best shown in FIGS. 12 and 13. As can be appreciated, once the reaction surfaces 292, 294 are released from engagement with the locking cams 228 and pawls 226, the pawls 226 are free to travel between the minor and major guide bosses 204, 206 relative to the inner and outer housing plates 178, 176. Upon sufficient rotation of the main cam 230, the third reaction surfaces 295 of the minor fingers 290 engage the second reaction surfaces 245 of the pockets 244 of the pawls 226. Further counterclockwise rotation of the main cam 230 displaces the pawls 226 radially inward. The plurality of teeth 236 on the arcuate surfaces 238 of the pawls 226 disengage the plurality of teeth 222 on the inner surface of the central aperture 216 of the sector plate 180. This permits the sector plate 180 to rotate relative to the inner and outer housing plates 178, 176. At this point, the recliner mechanism 174 is in the unlocked position.

To return the recliner mechanism 174 to the locked condition, the clockwise force is released from the main pivot 272 such that the coil spring 296 is permitted to once again bias the main pivot 272. The coil spring 296 will bias the main pivot 272 and rotate the main cam 230 clockwise into the locked position. Specifically, sufficient rotation of the main cam 230 will cause the first reaction surfaces 292 of the major fingers 288 of the first and second arms 264, 266 to abuttingly engage the second reaction surfaces 260 on the locking cams 228. Consequently, the first reaction surfaces 258 on the locking cams 228 abuttingly engage the third reaction surfaces 248 of the pawls 226. Additionally, the second reaction surfaces 294 of the minor fingers 290 of the main cam 230 abuttingly engage the first reaction surfaces 246 of the hips 240 of the pawls 226. This combination of abutting engagements secures the plurality of teeth 236 on the pawls 226 into engagement with the plurality of teeth 222 of the central aperture 216 of the sector plate 180.

The recliner mechanism 174 is held in the locked position due the interaction between the main cam 230, locking cams 228, and pawls 226, as previously discussed. The rotational force imparted on the main cam 230 due to the coil spring 296, causes the reaction surfaces 292 to contact the second reaction surfaces 260 of the respective locking cams 228, thereby causing the locking cams 228 to rotate about rivets 184 and engage the pawls 226. More particularly, the reaction surfaces 258 on the locking cams 228 engage the reaction surfaces 248 of the respective pawls 226 and apply a primary force X thereon. Due to the angular relationship between reaction surfaces 248 and the locking cams 228, the primary force X is applied at an angle Θ relative to the pawls 226, whereby Θ is substantially between 14-22 degrees.

The primary force X comprises resultant forces Y and Z due to the angular relationship between reaction surface 248 and locking cams 228, as best shown in FIG. 10. Resultant force Y imparts a force on the pawls 226 generally normal to the teeth 222, 236 and serves to hold the pawls 226 in contact with the teeth 222 of the sector plate 180. Resultant force Z applies a force generally in the direction of rotation of the sector plate 180 and serves to maintain the teeth 222 of the sector plate 180 in engagement with the teeth 236 of the pawls 226. In this manner, the resultant forces Y, Z restrict movement between the teeth 222 of the sector plate 180 and the teeth 236 of the pawls 226 such that even small variations between the teeth 222, 236 are prevented from causing a slip or rattle condition during use.

The angular relationship between reaction surfaces 258 of the locking cams 228 and the reaction surfaces 248 of the pawls 248 allows the sector plate 180 to be securely held in the locked position when the pawls 226 are engaged with the sector plate 180. In addition, such an angular relationship (i.e. where Θ is substantially between 14-22 degrees) reduces the force required to overcome the interaction between the locking cams 228 and the pawls 226. In other words, the angular relationship ensures that the main cam 230, locking cams 228, and pawls 226 will sufficiently lock the sector plate 180 relative to the inner and outer housing plates 178, 176 while concurrently optimizing the force required to release the pawls 226 from engagement with the sector plate 180 and permit rotation of the sector plate 180 relative to the inner and outer housing plates 178, 176.

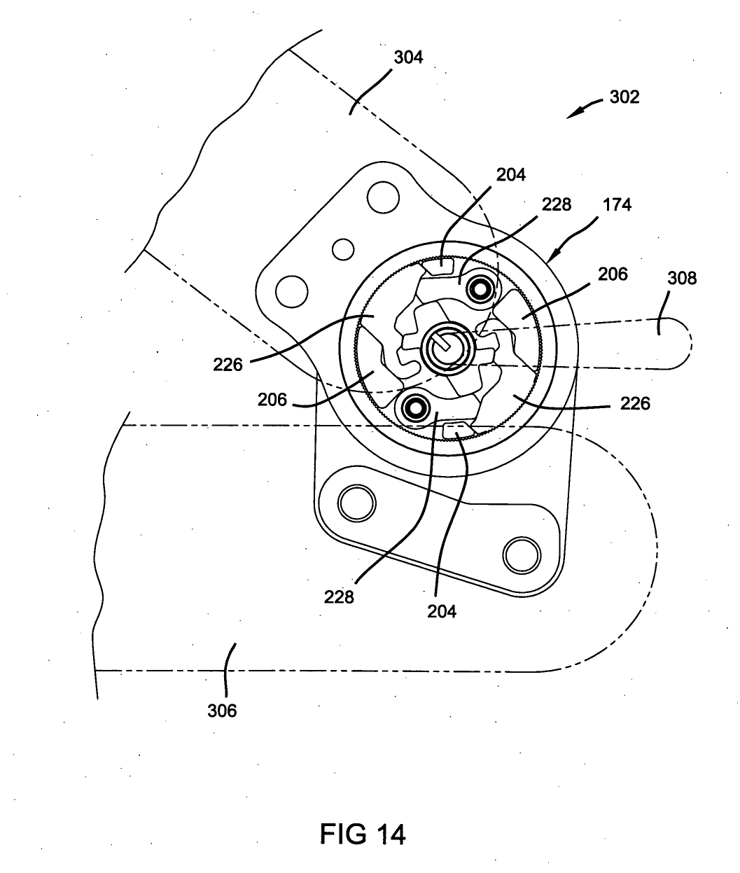

With respect to FIG. 14, a seat assembly 302 is shown incorporating the recliner mechanism 174 of the present invention. The seat assembly 302 includes a seat back 304, a seat bottom 306, and an actuation handle 308. The seat back 304 is pivotably supported by the seat bottom 306 having the recliner mechanism 174 disposed therebetween. The actuation handle 308 is fixedly attached to the main pivot 272 such that a rotational force applied to the actuation handle 308 is transmitted to the main pivot 272.

In one embodiment, the sector plate 180 is fixedly attached to the seat back 304 and the outer housing plate 176 is fixedly attached to the seat bottom 306 such that rotation of the sector plate 180 relative to the outer housing plate 176 causes concurrent rotation of the seat back 304 relative to the seat bottom 306. Alternatively, the sector plate 180 could be fixedly attached to the seat bottom 306 and the outer housing plate 176 fixedly attached to the seat back 304 such that rotation of the outer housing plate 176 relative to the sector plate 180 causes concurrent rotation of the seat back 304 relative to the seat bottom 306.

In either configuration, a force is applied to the actuation handle 308 to rotate the main pivot 272 against the bias of coil spring 296. As previously discussed, such rotation will cause the main cam 230 to rotate and release the pawls 226 from engagement with the sector plate 180. Once the pawls 226 are released, a force may be applied to rotate the seat back 304 relative to the seat bottom 306. Once the desired position for the seat back 304 is achieved, the actuation handle 308 is released, and the pawls 226 will re-engage the sector plate 180, thereby locking the seat back 304 in the desired position relative to the seat bottom 306.

The description of the invention is merely exemplary in nature and, thus, variations that do not depart from the gist of the invention are intended to be within the scope of the invention. Such variations are not to be regarded as a departure from the spirit and scope of the invention.

1. A recliner assembly comprising:
a first housing plate;
a second housing plate rotatably supported by said first housing plate;
a first pawl movable between a locked position engaging said second housing plate and an unlocked position disengaged from said second housing plate, said pawl operable to apply a primary force to said second housing plate in a locked position having a first force component generally normal to the engagement of said pawl and said second housing plate and a second force component generally perpendicular to said first force component;
a first locking cam rotatably supported by said first housing plate; and
a main cam rotatably supported by said first housing plate, said main cam operable to selectively rotate said first locking cam into engagement with said first pawl to urge said first pawl into said locked position.

2. The recliner assembly of claim 1 further comprising a second pawl, said second pawl movable between a locked position engaging said second housing plate to prohibit rotation of said second housing plate relative to said first housing plate and an unlocked position disengaging said second housing plate to enable rotation of said second housing plate relative to said first housing plate.

3. The recliner assembly of claim 2 further comprising a second locking cam, said second locking cam rotatably supported by said first housing plate and operable to engage said second pawl to urge said second pawl into said locked position in response to rotation of said main cam.

4. The recliner assembly of claim 1 further comprising a release cam, said release cam rotatably supported by said first housing plate and operable to toggle said first pawl between said locked and unlocked positions.

5. The recliner assembly of claim 4, wherein said release cam includes a cam surface slidably engaging said first pawl to toggle said first pawl between said locked and unlocked positions.

6. The recliner assembly of claim 1 further comprising a biasing member, said biasing member acting on said main cam to bias said main cam into engagement with said first locking cam to thereby urge said first pawl into said locked position.

7. The recliner assembly of claim 1, wherein said first locking cam includes an engagement face operable to selectively receive said main cam.

8. The recliner assembly of claim 7, wherein said engagement face is formed at an angular relationship with said first pawl, said engagement face operable to apply said primary force to said first pawl at an angle between 14-22 degrees.

9. The recliner assembly of claim 1, wherein said main cam includes a first engagement arm and a second engagement arm, said first engagement arm in contact with said first pawl to selectively toggle said pawl between said locked and unlocked positions and said second engagement arm positioned a predetermined distance away from said first pawl when said first pawl is in said locked position.

10. A recliner assembly comprising:
a first housing plate;
a second housing plate rotatably supported by said first housing plate;
a first pawl comprising a first and second arm, said first pawl slidably supported by said first housing plate and movable between a locked position engaging said second housing plate to prohibit rotation of said second housing plate relative to said first housing plate and an unlocked position disengaging said second housing plate to enable rotation of said second housing plate relative to said first housing plate;
a first locking cam rotatably supported by said first housing plate and operable to engage said first arm of said first pawl to urge said first pawl into said locked position; and
a main cam comprising a first extension and a second extension, said first extension abutting said first locking cam to rotate said locking cam and urge said first pawl into said locked position and said second extension spaced apart a predetermined distance from said second arm of said first pawl when said first pawl is in said locked position.

11. The recliner assembly of claim 10, wherein said first pawl includes a recess formed between said first and second arms.

12. The recliner assembly of claim 11 further comprising a post fixedly attached to said first housing plate, said post slidably engaging said recess of said first pawl and operable to define a range of movement for said first pawl between said locked and unlocked positions.

13. The recliner assembly of claim 10 further comprising a release cam, said release cam rotatably supported by said first housing plate and operable to toggle said first pawl between said locked and unlocked positions.

14. The recliner assembly of claim 13, wherein said release cam includes a cam surface slidably engaging said first pawl to toggle said first pawl between said locked and unlocked positions.

15. The recliner assembly of claim 10, wherein said main cam further comprises a third and fourth extension, said third and fourth extension formed opposite said first and second extensions.

16. The recliner assembly of claim 15 further comprising a second locking cam and a second pawl, said second pawl including a first arm and a second arm.

17. The recliner assembly of claim 16, wherein said third extension of said main cam is in abutting engagement with said second locking cam and said fourth extension of said main cam is disposed a predetermined distance from said second arm of said second pawl when said second pawl is in a locked position.

18. A recliner assembly comprising:
a first housing plate;
a second housing plate rotatably supported by said first housing plate;
a first pawl slidably supported by said first housing plate and movable between a locked position engaging said second housing plate to prohibit rotation of said second housing plate relative to said first housing plate and an unlocked position disengaging said second housing plate to enable rotation of said second housing plate relative to said first housing plate;
a first locking cam rotatably supported by said first housing plate and operable to engage said first pawl to urge said first pawl into said locked position; and
a main cam comprising a first extension and a second extension, said first extension abutting said first locking cam to rotate said locking cam and apply a primary force to said first pawl, said primary force having a first force component generally normal to the engagement of said first pawl and said second housing plate and a second force component generally perpendicular to said first force component.

19. The recliner assembly of claim 18, wherein said first pawl includes an arm engaged by said second extension of said main cam when in said locked position.

20. The recliner assembly of claim 19 further comprising a boss formed on said first housing plate, said boss slidably engaging said first pawl between said locked and unlocked positions.

21. The recliner assembly of claim 18, wherein said main cam further comprises a third and fourth extension, said third and fourth extension formed opposite said first and second extensions.

22. The recliner assembly of claim 21 further comprising a second locking cam and a second pawl.

23. The recliner assembly of claim 22, wherein said third extension of said main cam is in abutting engagement with said second locking cam and said fourth extension of said main cam is in abutting engagement with an arm on said second pawl.

24. A seat assembly comprising:
a seat bottom;
a seat back pivotably supported by said seat bottom; and
a recliner assembly disposed between said seat bottom and said seat back to selectively restrict rotation of said seat back relative to said seat bottom, said recliner assembly comprising:
a first housing plate fixedly attached to one of the seat bottom and seat back;
a second housing plate rotatably supported by said first housing plate and fixedly attached to the other of said seat bottom and seat back;
a first pawl movable between a locked position engaging said second housing plate and an unlocked position disengaged from said second housing plate, said pawl operable to apply a primary force to said second housing plate in a locked position having a first force component generally normal to the engagement of said pawl and said second housing plate and a second force component generally perpendicular to said first force component;
a first locking cam rotatably supported by said first housing plate; and
a main cam rotatably supported by said first housing plate, said main cam operable to selectively rotate said first locking cam into engagement with said first pawl to urge said first pawl into said locked position.

25. The seat assembly of claim 24 further comprising a release cam, said release cam rotatably supported by said first housing plate and operable to toggle said first pawl between said first and second positions.

26. The seat assembly of claim 25, wherein said release cam includes a cam surface slidably engaging said first pawl to toggle said first pawl between said locked and unlocked positions.

27. The seat assembly of claim 26 further comprising a handle, said handle coupled to said release cam to selectively toggle said recliner assembly between said locked and unlocked positions in response to an external force applied thereto.

28. The seat assembly of claim 24 further comprising a biasing member, said biasing member acting on said main cam to bias said main cam into engagement with said first locking cam to thereby urge said first pawl into said locked position.

29. The seat assembly of claim 28 further comprising a second pawl and a second locking cam, said second locking cam operable to urge said second pawl into engagement with said first housing plate in response to rotation of said main cam to thereby selectively prevent rotation of said second housing plate relative to said first hosing plate.

30. The seat assembly of claim 29 further comprising a gap disposed between said first and second pawls and said main cam when said first and second pawls are in said locked position, said gap operable to allow interaction between said first and second pawls and said main cam to further lock said fist housing plate to said second housing plate when a predetermined load is applied to said seat bottom or said seat back.

31. The seat assembly of claim 24, wherein said primary force is applied to said first pawl at an angle between 14-22 degrees.
